(19) United States
(12) Patent Application Publication
(10) Pub. No.: US 2007/0005841 A1
(43) Pub. Date: Jan. 4, 2007

(54) Data differential signal transmission and keyboard/video/mouse/audio switch

(76) Inventors: Tzu-Chieh Lin, Taipei (TW); Chien-Feng Lee, Taipei (TW); Shang-Tai Shao, Taipei (TW)

Correspondence Address: RABIN & Berdo, PC, 1101 14TH STREET, NW, SUITE 500, WASHINGTON, DC, 20005, US

(21) Appl. No.: 11/296,280

(22) Filed: Dec. 8, 2005

Related U.S. Application Data
(60) Provisional application No. 60/684,976, filed on May 27, 2005.

(51) Int. Cl. G06F 13/38

(52) U.S. Cl. 710/62

(57) ABSTRACT

A differential signal transmission system and keyboard, video, mouse, audio signal switch includes a data encoder for encoding the data of an input/output device; a data differential driver for transmitting data to a remote site in a positive phase and negative phase respectively; a data differential receiver, settled at the remote site, for receiving the positive phase and negative phase data; and a data decoder for decoding the data.

### CROSS-REFERENCE TO RELATED APPLICATIONS

This non-provisional application claims priority under 35 U.S.C. §119(e) on Provisional Patent Application No(s). 60/684,976 filed in United States on May 27, 2005, the entire contents of which are hereby incorporated by reference.

### BACKGROUND OF THE INVENTION

1. Field of Invention

The invention generally relates to a differential signal transmission system, and in particular relates to a differential signal transmission system and a keyboard/video/mouse/audio signal switch.

2. Related Art

Computers play an important role in modern human lives of each family and enterprise. In some situations, a user may have to operate several computers at a time. In order to save space and cost or even to facilitate the operations, new computer application structure turns into sharing a set of input, monitoring and control device for multiple computers. The sharing helps effective input, monitoring and operations of the computers.

The aforesaid sharing is mainly approached by switch devices, such as switches for keyboard, video signals or mouse. The switches are connected, extended or switched by users to select different computers connected to the same operation device for input, monitoring and operations of the computers.

As shown in FIG. 1 of prior arts, several computers 10, 11, 12 . . . are sharing a monitor 13 through a switch device 20. The switch device 20 works as an interface to link the monitor 13 to one of the computers 10, 11, 12 for showing information of the specific computer at a time. Meanwhile, data from a keyboard 14 and a mouse 15 are also switched to the specific computer. The switch device can also share other input or output devices, such as microphone, speaker or other peripherals, with multiple computers.

In the recent high frequency electronic circuits, the increasing density of components causes signal interference and electromagnetic radiation problems more and more serious. The high frequency keyboard, video or mouse switch is easy to be interfered by noise and lowered the transmission quality. In order to resist signal interference, some signal transmission systems apply differential signal transmission method. It may effectively resist noise interference, and also simplify the electronic circuit. However, such kind of differential signal transmission has not been developed for a keyboard/video/mouse/audio signal switch.

Therefore, how to provide a differential signal transmission system and a keyboard, video, mouse or audio switch, so as to reduce noise interference and to improve signal transmission quality, remains an unresolved problem of researchers.

### SUMMARY OF THE INVENTION

In view of the aforesaid problem, the object of the invention is to provide a differential signal transmission system and a keyboard, video, mouse or audio switch. The differential signal transmission reduces noise interference and improves signal transmission quality.

To achieve the object, the differential signal transmission system of the invention includes a data encoder for encoding the data of an input/output device; a data differential driver for transmitting data to a remote site in a positive phase and a negative phase respectively; a data differential receiver, settled at the remote site, for receiving the positive phase and the negative phase data; and a data decoder for decoding the data.

The differential signal transmission system further includes a signal transmitter, a differential signal driver, a network transmission interface, a differential signal receiver and a signal decoder.

The signal transmitter processes video signals into differential transmission signals. The video signals include red, green, blue, vertical and horizontal signals.

The differential signal driver transfers respectively the red, green, blue, vertical and horizontal signals with positive phase and negative phase to the remote site. The differential signal driver is composed of differential integrated circuits.

The network transmission interface provides a signal transmission medium for transmitting video signal. The network transmission interface can be an Ethernet transmission line. The differential signal receiver, located at the remote site, receives the positive phase and negative phase of red, green, blue, vertical and horizontal signals. The differential signal receiver is composed of differential integrated circuits.

The signal decoder decodes the received signals into video signals. The video signals include red, green, blue, vertical and horizontal signals.

To achieve the object, a keyboard, video, mouse or audio signal switch of the invention is settled at a transmitting site and a receiving site (remote site) respectively. The keyboard, video, mouse or audio signal switch at the transmitting site includes a data encoder for encoding the data of an input/output device, and a data differential driver for transmitting data to the remote site in a positive phase and a negative phase respectively.

The keyboard, video, mouse or audio signal switch at the transmitting site further includes a signal transmitter, a differential signal driver and a network transmission interface.

The signal transmitter processes video signals into compressed video signals and transmits to the remote site. The video signals include red, green, blue, vertical and horizontal signals.

The differential signal driver transfers video signals with positive phase and negative phase respectively to the remote site. The differential signal driver is composed of differential integrated circuits.

The network transmission interface provides a signal transmission medium for transmitting video signals. The network transmission interface can be an Ethernet transmission line. The receiving site, correspondent to the transmitting site, includes a data differential receiver for receiving the positive phase and negative phase video signals; and a data decoder for decoding the data.

The keyboard, video, mouse or audio signal switch at the receiving site further includes a differential signal receiver, a signal receiver and a network transmission interface.

The differential signal receiver receives the positive phase and negative phase video signals. The differential signal receiver is composed of differential integrated circuits.

The signal receiver retrieves the video signals. The video signals include red, green, blue, vertical and horizontal signals.

The network transmission interface provides a signal transmission medium for transmitting video signals. The network transmission interface can be an Ethernet transmission line.

The differential signal transmission system and keyboard, video, mouse or audio signal switch transmits video signals and data in a differential method, so as to reduce noise interference and improve signal transmission quality.

Further scope of applicability of the present invention will become apparent from the detailed description given hereinafter. However, it should be understood that the detailed description and specific examples, while indicating preferred embodiments of the invention, are given by method of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a schematic diagram of an application of prior arts sharing a monitor, a keyboard and a mouse among multiple computers through a switch device;

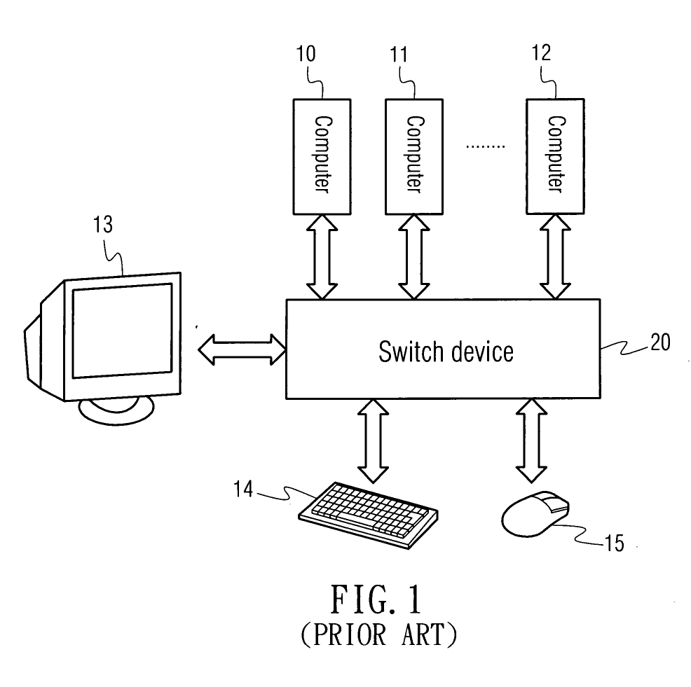

FIG. 2A is a block diagram of a differential signal transmission system as the first embodiment of the invention; and

FIG. 2B is a block diagram of a differential signal transmission system as the second embodiment of the invention.

### DETAILED DESCRIPTION OF THE INVENTION

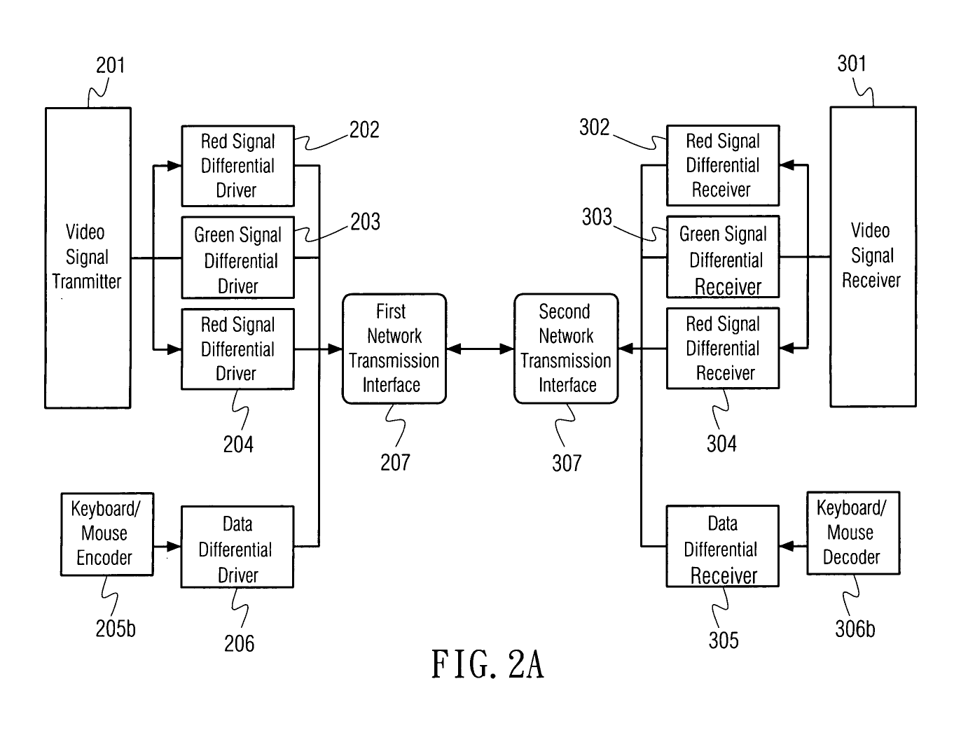

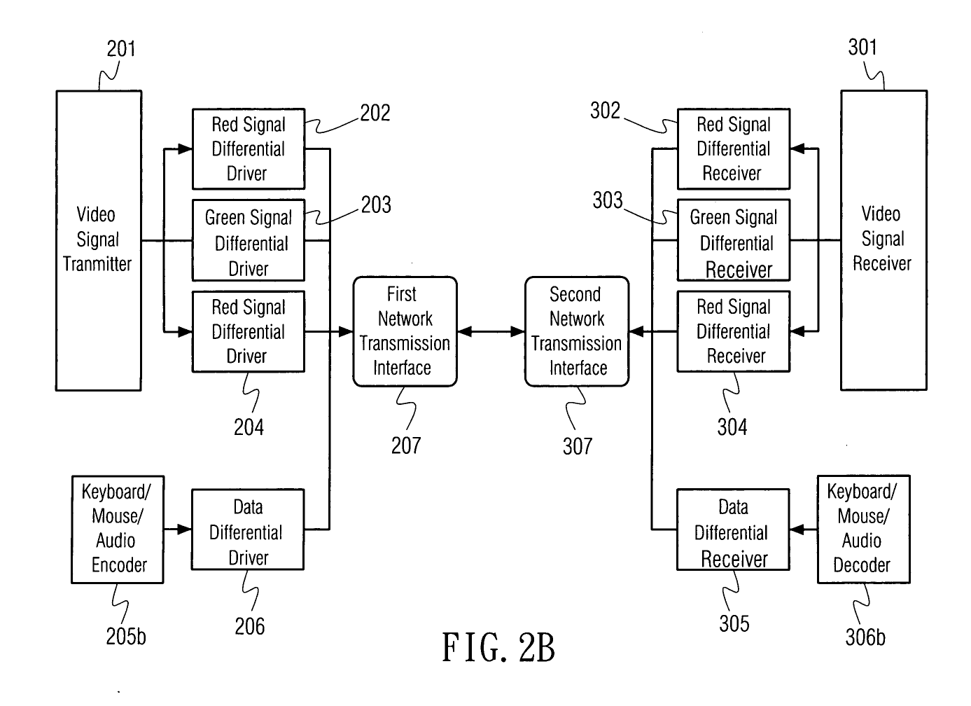

As shown in FIG. 2A, a block diagram of the first embodiment of the invention, a differential signal transmission system serves between a transmitting site and a receiving (remote) site. At the transmitting site, there are a video signal transmitter 201, a red signal differential driver 202, a green signal differential driver 203, a blue signal differential driver 204, a keyboard/mouse encoder 205a, a data differential driver 206 and a first network transmission interface 207.

The video signal transmitter 201 processes the signals into differential signal transmission formats and transmits them to the remote site. The video signals include red, green, blue, vertical and horizontal signals.

The red signal differential driver 202 is connected with the video signal transmitter 201 for transmitting positive phase and negative phase of each bit of red signal to the remote site through a driving circuit (not shown). In other words, the signals are transmitted in complementary pairs so that the electromagnetic fields generated in the transmission line counteract to each other so as to reduce noise interference. The red signal differential driver 202 is composed of integrated circuits.

The green signal differential driver 203 is connected with the video signal transmitter 201 for transmitting positive phase and negative phase of each bit of green signal to the remote site through a driving circuit (not shown). In other words, the signals are transmitted in complementary pairs so that the electromagnetic fields generated in the transmission line counteract to each other so as to reduce noise interference. The green signal differential driver 203 is composed of integrated circuits.

The blue signal differential driver 204 is connected with the video signal transmitter 201 for transmitting positive phase and negative phase of each bit of blue signal to the remote site through a driving circuit (not shown). In other words, the signals are transmitted in complementary pairs so that the electromagnetic fields generated in the transmission line counteract to each other so as to reduce noise interference. The blue signal differential driver 204 is composed of integrated circuits.

The keyboard/mouse encoder 205a encodes the data of an input/output device (such as a keyboard or a mouse) via an encoding circuit (not shown) or software for transforming the data into a signal transmission format suitable for network transmission, and compressing and sending the data to the remote site. The keyboard/mouse encoder 205a can be a single chip (such as 16F87X) or a complex programmable logic device (CPLD).

The data differential driver 206 is connected with the keyboard/mouse encoder 205a for transmitting the positive phase and negative phase of each bit of keyboard/mouse data to the remote site via a driving circuit (not shown). In other words, the signals are transmitted in complementary pairs so that the electromagnetic fields generated in the transmission line counteract to each other so as to reduce noise interference.

The first network transmission interface 207, connected respectively with the red signal differential driver 202, green signal differential driver 203, blue signal differential driver 204, and data differential driver 206, provides a signal transmission medium for transmitting video signals. The first network transmission interface 207 can be a twisted-pair Ethernet transmission line for transmitting data to the remote site. The twisted-pair line (not shown) includes four pairs of twisted lines, in which three pairs transmit respectively the red, green, blue signals and vertical and horizontal signals. The vertical and horizontal signals are transmitted to the remote site via carrier waves. The rest one pair of twisted lines transfers data signal.

At the receiving site, there are a video signal receiver 301, a red signal differential receiver 302, a green signal differential receiver 303, a blue signal differential receiver 304, a data differential receiver 305, a keyboard/mouse decoder 306a, and a second network transmission interface 307.

The video signal receiver 301, connected respectively to the red signal differential receiver 302, the green signal differential receiver 303 and the blue signal differential receiver 304, retrieves the received video signals. The received video signals include red, green, blue, vertical and horizontal differential signals.

The red signal differential receiver 302, connected with the second network transmission interface 307, receives and sums the positive phase and negative phase red signals of each bit via a receiving circuit (not shown) to retrieve the red signals. Besides, because of the characteristic of the differential signal transmitting, the red signals can obtain a better signal quality. The red signal differential receiver 302 is composed of differential integrated circuits.

The green signal differential receiver 303, connected with the second network transmission interface 307, receives and sums the positive phase and negative phase green signals of each bit via a receiving circuit (not shown) to retrieve the green signals. Besides, because of the characteristic of the differential signal transmitting, the green signals can obtain a better signal quality. The green signal differential receiver 303 is composed of differential integrated circuits.

The blue signal differential receiver 304, connected with the second network transmission interface 307, receives and sums the positive phase and negative phase blue signals of each bit via a receiving circuit (not shown) to retrieve the blue signals. Besides, because of the characteristic of the differential signal transmitting, the blue signals can obtain a better signal quality. The blue signal differential receiver 304 is composed of differential integrated circuits.

The data differential receiver 305, connected with the second network transmission interface 307, receives and sums the positive phase and negative phase of each bit of keyboard/mouse data via a receiving circuit (not shown) to retrieve the keyboard/mouse data.

The keyboard/mouse decoder 306a, connected with the data differential receiver 305, decodes the received keyboard/mouse data via a decoding circuit (not shown) or software, and decompresses the data and executes relative controls of the computers. The keyboard/mouse decoder 306a can be a single chip (such as 16F87X) or a complex programmable logic device (CPLD).

The second network transmission interface 307, connected respectively with the red signal differential receiver 302, green signal differential receiver 303, blue signal differential receiver 304 and data differential receiver 305, provides a signal transmission medium for receiving video signals. The second network transmission interface 307 can be a twisted-pair Ethernet transmission line for receiving data from the transmitting site. The twisted-pair line (not shown) includes four pairs of twisted lines, in which three pairs receive respectively the red, green, blue signals and vertical and horizontal signals. The vertical and horizontal signals are received from the transmitting site via carrier waves. The rest one pair of twisted lines receives data signal.

FIG. 2B is a block diagram of a differential signal transmission system as the second embodiment of the invention. It differs from the first embodiment at the data transmission and receiving portions. The data encoder 205a of the first embodiment includes keyboard and mouse encoders, while the data encoder 205b of the second embodiment includes keyboard, mouse and audio encoder. In addition, the data decoder 306a of the first embodiment includes keyboard and mouse decoders, while the data decoder 306b of the second embodiment includes keyboard, mouse and audio decoder. The rests are the same. The keyboard/mouse/audio encoder 205b encodes the keyboard, mouse or audio data via an encoding circuit (not shown) or software for transforming the data into a signal transmission format suitable for network transmission, and compressing and sending the data to the remote site. The keyboard/mouse/audio encoder 205b can be a complex programmable logic device (CPLD).

The keyboard/mouse/audio decoder 306b, connected with the data differential receiver 305, decodes the received keyboard/mouse/audio data via a decoding circuit (not shown) or software, and decompresses the data and executes relative controls of the computers. The keyboard/mouse/audio decoder 306b can be a complex programmable logic device (CPLD).

The invention is applicable to long distance transmission systems among meeting rooms, factories, educational applications, communication stations and so on.

The differential signal transmission system and keyboard, video, mouse or audio signal switch transmits video signals and data in a differential method, so as to reduce noise interference and improve signal transmission quality.

The invention being thus described, it will be obvious that the same may be varied in many methods. Such variations are not to be regarded as a departure from the spirit and scope of the invention, and all such modifications as would be obvious to one skilled in the art are intended to be included within the scope of the following claims.

1. A differential signal transmission system of a keyboard/video/mouse switch, for transmitting a signal of the keyboard/video/mouse switch to a remote, comprising:
a signal encoder for encoding the signal;
a differential signal driver for differentially transmitting the signal to the remote;
a network transmission interface for acting as a transmission interface to transmit the signal;
a data differential receiver at the remote for receiving the differentially transmitted signal; and
a data decoder for decoding the signal.

2. The differential signal transmission system according to claim 1 wherein the differential signal driver comprises a differential integrated circuit.

3. The differential signal transmission system according to claim 1 wherein the differential signal receiver comprises a differential integrated circuit.

4. The differential signal transmission system according to claim 1 further comprising:
a data encoder for encoding a data received by an input/output device;
a data differential driver, for differentially transmitting the data to the remote;
a data differential receiver for receiving the differentially transmitted data; and
a data decoder for decoding the data.

5. The differential signal transmission system according to claim 4 wherein the data differential signal driver comprises a differential integrated circuit.

6. The differential signal transmission system according to claim 4 wherein the data differential signal receiver comprises a differential integrated circuit.

7. The differential signal transmission system according to claim 1 wherein the signal comprises a video signal and a data.

8. The differential signal transmission system according to claim 7 wherein the video signal comprises a red signal, a green signal, a blue signal, a vertical signal and a horizontal signal.

9. The differential signal transmission system according to claim 1 wherein the network transmission interface is an Ethernet transmission port (RJ-45).

10. The differential signal transmission system according to claim 1 wherein the data comprises a keyboard and a mouse.

11. The differential signal transmission system according to claim 1 wherein the data comprises a keyboard, a mouse and an audio.

12. A keyboard/video/mouse switch of a differential signal transmission system, for transmitting a signal of the keyboard/video/mouse switch to a remote, comprising:
a signal encode, for encoding the signal;
a differential signal driver, for differentially transmitting the signal to the remote; and
a network transmission interface for acting as a transmission interface to transmit the signal.

13. The differential signal transmission system according to claim 12 wherein the differential signal driver comprises a differential integrated circuit.

14. The differential signal transmission system according to claim 12 further comprising:
a data encoder for encoding a data received by an input/output device; and
a data differential driver for differentially transmitting the data to the remote.

15. The differential signal transmission system according to claim 14 wherein the differential signal driver comprises a differential integrated circuit.

16. The differential signal transmission system according to claim 12 wherein the signal comprises a video signal and a data.

17. The differential signal transmission system according to claim 16 wherein the video signal comprises a red signal, a green signal, a blue signal, a vertical signal and a horizontal signal.

18. The differential signal transmission system according to claim 12 wherein the network transmission interface is an Ethernet transmission port (RJ-45).

19. The differential signal transmission system according to claim 12 wherein the signal comprises a video signal and a data.

20. The differential signal transmission system according to claim 12 wherein the data comprises a keyboard, a mouse and an audio.
